(19) United States
(12) Patent Application Publication
(10) Pub. No.: US 2025/0264935 A1
(43) Pub. Date: Aug. 21, 2025

(54) METHODS AND SYSTEMS SUPPORTING MULTI-DISPLAY INTERACTION USING WEARABLE DEVICE

(71) Applicant: HUAWEI TECHNOLOGIES CO., LTD., Shenzhen (CN)

(72) Inventors: Qiang XU, Kanata (CA); Ting LI, Shenzhen (CN); Gaganpreet SINGH, Kanata (CA); Tia FANG, Kanata (CA); Junwei SUN, Kanata (CA)

(21) Appl. No.: 19/196,851

(22) Filed: May 2, 2025

Related U.S. Application Data
(63) Continuation of application No. PCT/CN2022/130094, filed on Nov. 4, 2022.

(51) Int. Cl. G06F 3/01; G06F 3/0346

(52) U.S. Cl. CPC G06F 3/012; G06F 3/0346

(57) ABSTRACT

Methods and systems supporting multi-display interaction using a wearable device are disclosed. A first set of inertial measurements representing motion of a head of a user is obtained. A first mapping between the first set of inertial measurements and a first display device is determined when detecting a first user interaction associated with the first display device of a plurality of display devices.

### CROSS-REFERENCE TO RELATED APPLICATIONS

The present disclosure is a continuation of PCT Application No. PCT/CN2022/130094, filed on Nov. 4, 2022, entitled “METHODS AND SYSTEMS SUPPORTING MULTI-DISPLAY INTERACTION USING WEARABLE DEVICE”, the disclosure of which is hereby incorporated by reference in its entirety.

### TECHNICAL FIELD

The present disclosure relates to methods and systems supporting multi-display user interactions, where a wearable device having an inertial sensor (e.g., inertial measurement unit (IMU) or inertial-magnetic measurement unit (IMMU)) is used.

### BACKGROUND

A user may have multiple display devices (e.g., multiple screens) displaying content and may switch attention between different display devices while working. Conventionally, a user must manually (e.g., using an input device such as a mouse) move a cursor between the display devices in order to interact with content on the different display devices.

To help improve efficiency of user interactions, there have been developments that attempt to track or detect the display device that the user is currently looking at, so that the user does not need to manually move the cursor to the display device of interest. Existing techniques may use infrared light-emitting diode (LED) markers and/or cameras to track a user's visual attention (e.g., using gaze tracking technology). However, such techniques may be costly to implement (e.g., requiring the use of many costly infrared markers and cameras) and/or may be computationally complex (which may result in inefficient use of computing resources).

Accordingly, it would be useful to provide improved methods and systems that support multi-display interactions.

### SUMMARY

In various examples, the present disclosure describes methods and systems supporting multi-display user interactions. A wearable device (e.g., smartglasses, smart earphones, head-mounted display, etc.) having an inertial sensor (e.g., an IMU or an IMMU) is used to detect a user's head pose. A first set of inertial measurements may be detected together with detection of user interaction associated with a first display device (e.g., user interaction with content displayed on the first display device), in order to register a mapping between the first set of inertial measurements and the first display device. The mapping may then be used to infer user attention and facilitate user interactions on the first display device when the first set of inertial measurements is again detected.

Examples of the present disclosure may provide a more intuitive and/or efficient way for a user to interact with multiple display devices. By registering a mapping between a detected head pose and a particular display device, a user's visual attention on that particular display device can be determined, which may provide a technical advantage in that the use of costly hardware or complex computations related to gaze tracking may be avoided.

In some examples, different types of user interactions may be supported, including various head-based user interactions. This may provide unique ways for a user to interact with content in a multi-display setup.

In some example aspects, the present disclosure describes a method including: obtaining a first set of inertial measurements representing motion of a head of a user; and determining a first mapping between the first set of inertial measurements and a first display device when detecting a first user interaction associated with the first display device of a plurality of display devices.

In an example of the preceding example aspect of the method, the method may also include: causing the first mapping to be stored.

In an example of any of the preceding example aspects of the method, the method may also include: obtaining a subsequent set of inertial measurements representing subsequent motion of the head of the user; identifying the first mapping matching the subsequent set of inertial measurements; and enabling further user interaction with content displayed on the first display device, based on the identified first mapping.

In an example of the preceding example aspect of the method, enabling the further user interaction may include: activating a cursor on the first display device, the cursor being activated at a location corresponding to a last user interaction on the first display device.

In an example of a preceding example aspect of the method, enabling the further user interaction may include: detecting scrolling input; and causing content displayed on the first display device to be scrolled based on the scrolling input.

In an example of a preceding example aspect of the method, enabling the further user interaction may include: controlling a display parameter of the first display device.

In an example of any of the preceding example aspects of the method, the first user interaction may be one of: voice input identifying the first display device; keyboard input to interact with content displayed on the first display device; mouse input to interact with content displayed on the first display device; or touch input sensed by a touch sensor of the first display device.

In an example of any of the preceding example aspects of the method, the method may include: obtaining a second set of inertial measurements representing motion of the head of the user; and determining a second mapping between the second set of inertial measurements and a second display device when detecting a second user interaction associated with the second display device of the plurality of display devices; where, in response to obtaining another set of inertial measurements matching the first mapping, user interaction with content displayed on the first display device may be enabled; and where, in response to obtaining another set of inertial measurements matching the second mapping, user interaction with content displayed on the second display device may be enabled.

In an example of the preceding example aspect of the method, the method may include: causing the second mapping to be stored.

In an example of the preceding example aspect of the method, the method may include: detecting selection of an object displayed on the first display device; obtaining a third set of inertial measurements representing motion of the head of the user; identifying the second mapping matching the third set of inertial measurements; and causing the selected object to be moved to be displayed on the second display device, based on the identified second mapping.

In an example of any of the preceding example aspects of the method, the method may include: obtaining a further set of inertial measurements indicating user movement above a defined threshold; and causing all stored mappings to be deleted.

In an example of any of the preceding example aspects of the method, the plurality of display devices may be controlled by a single electronic device.

In an example of any of the preceding example aspects of the method, the plurality of display devices may be controlled by multiple electronic devices.

In an example of any of the preceding example aspects of the method, inertial measurements may be obtained from an inertial sensor of a wearable device worn on or near the head of the user.

In some example aspects, the present disclosure describes a computing system including a processing unit configured to execute computer readable instructions to cause the computing system to perform any of the preceding example aspects of the method.

In an example of the preceding example aspect of the computing system, the computing system may include: an inertial sensor configured to obtain the set of inertial measurements; where the computing system may be configured to be wearable on or near the head of the user.

In some example aspects, the present disclosure describes a non-transitory computer readable medium having instructions encoded thereon, where the instructions are executable by a processing unit of a computing system to cause the computing system to perform any of the preceding example aspects of the method.

### BRIEF DESCRIPTION OF THE DRAWINGS

Reference will now be made, by way of example, to the accompanying drawings which show example embodiments of the present application, and in which:

FIG. 1 is a schematic diagram illustrating an example of a user interacting with multiple display devices, in accordance with examples of the present disclosure;

FIG. 2 is a block diagram illustrating an example of a setup with multiple display devices, in accordance with examples of the present disclosure;

FIG. 3 is a block diagram illustrating some components of an example computing system, in accordance with examples of the present disclosure;

FIG. 4 is a flowchart illustrating an example method for enabling user interaction in a multi-display setup, in accordance with examples of the present disclosure;

FIGS. 5A-5F illustrate an example implementation of the method of FIG. 4; and

FIG. 6 is a block diagram illustrating another example of a setup with multiple display devices, in accordance with examples of the present disclosure.

Similar reference numerals may have been used in different figures to denote similar components.

### DETAILED DESCRIPTION

Existing techniques for tracking a user's visual attention in a multi-display environment typically require the use of gaze tracking technology. This may require marking the different display devices with infrared light-emitting diode (LED) markers and/or using infrared cameras to detect and track the user's eyes. In addition to the need for costly hardware, complex computations may also be required. For example, to enable tracking of the user's visual attention, each display device may need to be registered in memory, then a camera may capture a scene that includes the multiple display devices in order to register the position of each display device. This information may then need to be correlated with data provided by the eye tracking camera. Finally, based on the registration of the display devices and the results of gaze detection algorithms an approximate fixation point representing the user's visual attention is calculated. As may be appreciated by one skilled in the art, such existing techniques may be costly and/or computationally complex, which may limit practical implementation.

A wearable device with an inertial sensor, such as an inertial measurement unit (IMU) or an inertial-magnetic measurement unit (IMMU), may be used to detect a user's head pose. However, there are difficulties to using an inertial sensor to track a user's visual attention. For example, it is often difficult to obtain accurate measurements of the user's head pose from an inertial sensor over a long time duration, due to drift and/or error accumulation in the sensor measurements. This means that frequent recalibration of the inertial sensor is required, for example using external cameras, which can be impractical in real-world applications.

The present disclosure provides examples which can use an inertial sensor on a wearable device to detect a user's visual attention on a particular display device in a multi-display setup, without the need for additional hardware. In examples disclosed herein, the need for explicit recalibration of the inertial sensor can be avoided by inferring the display device that is currently the target of the user's attention.

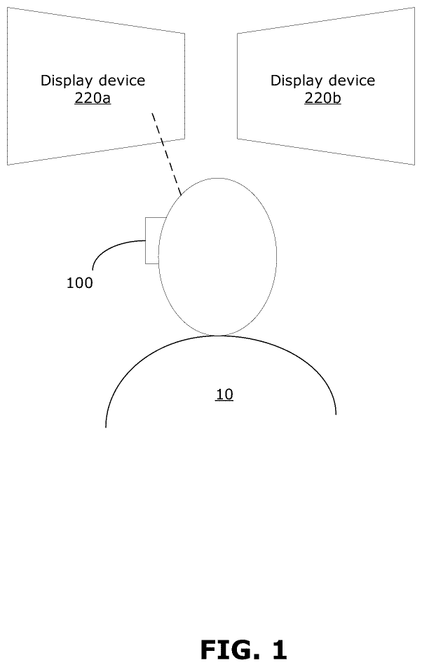

FIG. 1 illustrates an example of a user 10 interacting with multiple display devices, specifically first display device 220a and second display device 220b (generically referred to as display device 220), in a multi-display setup. Although two display devices 220 are shown, it should be understood that this is only exemplary and there may be more than two display devices 220 in a multi-display setup. The display devices 220a, 220b may be in communication with the same processing unit (e.g., a single desktop computer) or different processing units (e.g., two different laptop computers). The two display devices 220a, 220b may display different visual content, or may display multiple views of the same content (e.g., multiple views of the same software application). The user's visual attention, indicated by a dashed line, may be currently targeted on one display device 220a. In this example, the user 10 is wearing a wearable device 100 (e.g., an earpiece) on the head.

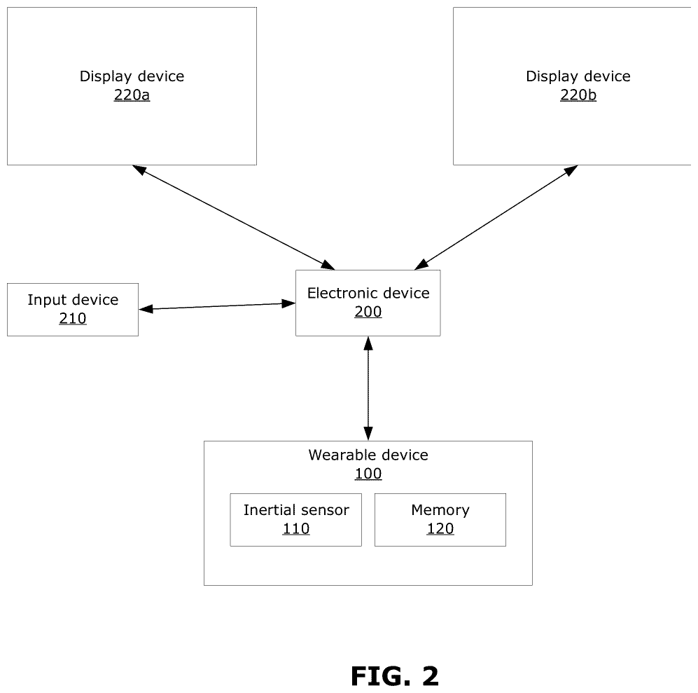

FIG. 2 is a block diagram illustrating some example computing hardware, which may be used in the example of FIG. 1.

In this example, each display device 220a, 220b is in communication (e.g., via a wired connection) with an electronic device 200 (e.g., a desktop computer). The electronic device 200 is also in communication with an input device 210 (e.g., a mouse, keyboard, touch interface, microphone, etc.). The user (not shown in FIG. 2) may interact with content displayed on each of the display devices 220a, 220b using the input device 210.

The electronic device 200 is also in communication with the wearable device 100, for example using a wireless connection such as a Bluetooth connection or using a wired connection. The wearable device 100 may be any smart device (e.g., an electronic device with wired or wireless communication capabilities) that can be worn on or near the user's head, such as smartglasses, smart earphones, head-mounted displays (HMDs), etc. The wearable device includes an inertial sensor 110 (e.g., IMU or IMMU). The inertial sensor 110 may be any suitable sensor capable of measuring the user's head pose, such as a 9-axis IMMU (e.g., having a 3-axis accelerometer, 3-axis gyroscope and 3-axis magnetometer), or other types of inertial sensors that may have higher or lower precision. In the example shown, the wearable device 100 includes a memory 120, which may store instructions for performing at least some of the functions disclosed herein. In other examples, the wearable device 100 may be in communication with an external memory (e.g., a memory of the electronic device 200, or a memory of another external device (not shown)).

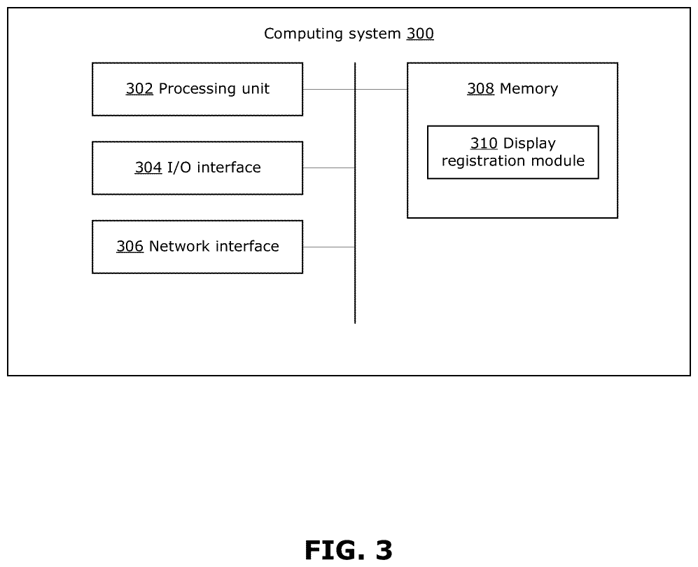

FIG. 3 is a block diagram showing some components of an example computing system 300 (which may also be referred to generally as an apparatus), which may be used to implement embodiments of the present disclosure. The computing system 300 may be used to perform methods disclosed herein. The computing system 300 may represent the wearable device 100, the electronic device 200, or another device that is in communication with the wearable device 100 and the electronic device 200. Although an example embodiment of the computing system 300 is shown and discussed below, other embodiments may be used to implement examples disclosed herein, which may include components different from those shown. Although FIG. 3 shows a single instance of each component, there may be multiple instances of each component shown.

The computing system 300 includes at least one processing unit 302, such as a processor, a microprocessor, an application-specific integrated circuit (ASIC), a field-programmable gate array (FPGA), a dedicated logic circuitry, a dedicated artificial intelligence processor unit, or combinations thereof. A processing unit 302 may have one or more processor cores.

The computing system 300 may include an input/output (I/O) interface 304. The I/O interface 304 may interface with input devices and/or output devices, depending on the embodiment. For example, if the computing system 300 represents the electronic device 200, the I/O interface 304 may interface with the input device 210 and the display devices 220. If the computing system 300 represents the wearable device 100, the I/O interface 304 may interface with the inertial sensor 110.

The computing system 300 may include a network interface 306 for wired or wireless communication with a network (e.g., an intranet, the Internet, a P2P network, a WAN and/or a LAN) or other device. For example, wired or wireless communication between the electronic device 200 and the wearable device 100 may be enabled by the network interface 306.

The computing system 300 includes a memory 308, which may include a volatile or non-volatile memory (e.g., a flash memory, a random access memory (RAM), and/or a read-only memory (ROM)). The non-transitory memory 308 may store instructions for execution by the processing unit 302, such as to carry out examples described in the present disclosure. For example, the memory 308 may include instructions, executable by the processing unit 302, to implement a display registration module 310, discussed further below. The memory 308 may include other software instructions, such as for implementing an operating system and other applications/functions. For example, the memory 308 may include software instructions for mapping a user's head pose to input commands, as disclosed herein.

In some examples, the computing system 300 may also include other electronic storage units (not shown), such as a solid state drive, a hard disk drive, a magnetic disk drive and/or an optical disk drive. In some examples, one or more data sets and/or modules may be provided by an external memory (e.g., an external drive in wired or wireless communication with the computing system 300) or may be provided by a transitory or non-transitory computer-readable medium. Examples of non-transitory computer readable media include a RAM, a ROM, an erasable programmable ROM (EPROM), an electrically erasable programmable ROM (EEPROM), a flash memory, a CD-ROM, or other portable memory storage. The components of the computing system 300 may communicate with each other via a bus, for example.

In examples of the present disclosure, inertial measurements from the wearable device 100 (e.g., obtained from the inertial sensor 110 of the wearable device 100) can be used to determine the head pose of the user 10 (e.g., relative to a global frame of reference, such as relative to the direction of gravity). In some examples, inertial measurements may be continuously obtained from the wearable device 100 when the wearable device 100 is active and in communication with the electronic device 200. When user interaction associated with the first display device 220a is detected, the display registration module 310 is used to obtain the current inertial measurements (which are used as a proxy for the user's head pose) and generate a mapping between the current inertial measurement and the first display device 220a. The mapping may be stored as a set of inertial measurements that is associated with the first display device 220a. The first display device 220a may then be considered “registered” with the display registration module 310. A similar process may be used to generate and store mappings for each other display device 220. The stored mappings may then be used later to determine whether the user 10 is looking at a particular display device 220. For example, if the inertial measurements obtained from the wearable device 100 correspond to the stored inertial measurements of a given mapping (e.g., the inertial measurements are within a defined range of the stored inertial measurements of the given mapping), then the content displayed on the display device 220 indicated by the given mapping may automatically be selected for user interaction (e.g., a cursor is activated for interacting with the content displayed on the display device 220).

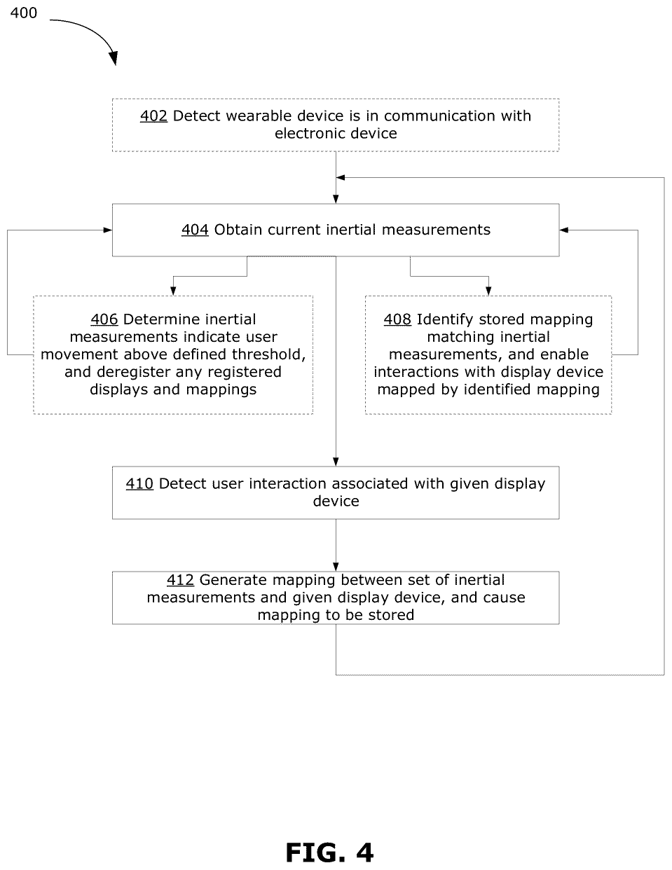

In this way, the inertial sensor 110 can be implicitly calibrated to register the spatial relationship between each display device 220 and the inertial measurements. The user interaction that is associated with a given display device 220 is used to infer that the user 10 is looking at the given display device 220, and the inertial sensor 110 can be calibrated relative to the given display device 220 accordingly. The user interaction may be any user interaction that is indicative of a specific display device 220, including an interaction with content displayed on the specific display device 220 (e.g., via a mouse input (e.g., mouse click), via keyboard input (e.g., text input), or via touch input (e.g., touch gesture on a touch-sensitive display device 220)), or interaction that selects the specific display device 220 (e.g., via voice input (e.g., voice input that is recognized as identifying a specific display device 220), or via touch input (e.g., touch gesture on a touch-sensitive display device 220)), among other possibilities. In this way, the need for explicit calibration of the inertial sensor 110 (e.g., requiring extensive explicit user input and/or requiring the use of external cameras) may be avoided. Further details will be described with respect to FIG. 4.

FIG. 4 is a flowchart illustrating an example method 400 for multi-display interactions using inertial measurements obtained from a wearable device. The method 400 may be executed by a computing system (e.g., the computing system 300, which may be embodied as the electronic device 200, the wearable device 100, or another computing device in communication with the electronic device 300 and the wearable device 100). The method 400 may include functions of the display registration module 310 and may be performed by a processing unit executing instructions to implement the display registration module 310, for example.

At 402, optionally, the method 400 may be initiated by detecting that the wearable device 100 is in communication with the electronic device 200 (e.g., a wireless connection has been established and is active between the wearable device 100 and the electronic device 200).

At 404, a set of inertial measurements is obtained representing motion of the user's head. For example, if the inertial sensor 110 of the wearable device 100 is a 9-axis IMMU, the set of inertial measurements may include nine measurements (corresponding to the 3 axes of an accelerometer, 3 axes of a gyroscope and 3 axes of a magnetometer). The set of inertial measurements may contain greater or fewer number of measurements, depending on the implementation of the inertial sensor 110.

How the set of inertial measurements is obtained may depend on the embodiment of the computing system that is carrying out the method 400. For example, if the method 400 is being implemented on the wearable device 100, the set of inertial measurements may be obtained by collecting data directly from the inertial sensor 110. If the method 400 is being implemented on the electronic device 200 or another computing device, the set of inertial measurements may be obtained by receiving the set of inertial measurements from the wearable device 100.

Optionally, at 406, if it is determined that the set of inertial measurements indicate user movement greater than a defined threshold, any registered display devices 220 may be deregistered from the display registration module 310, and any stored mappings between a display device 220 and a set of inertial measurements may be deleted. For example, if the set of inertial measurements indicate that the user is walking or is moving at a speed greater than a defined threshold, this may mean that the user has moved away from the display devices 220. Even if the user returns to the display devices 220 later, it may be necessary to generate new mappings because the inertial measurements may have drifted during the time the user had moved away. Following step 406, the method 400 may return to step 404 to continue monitoring the inertial measurements.

Optionally, at 408, if there is already a stored mapping matching the set of inertial measurements that mapping may be identified, and user interactions may be enabled for the display device 220 mapped by the identified mapping. Identifying the mapping may involve querying a table of stored mappings, which may be stored locally or externally.

A match between the set of inertial measurements and a stored mapping may be determined if the set of inertial measurements is within a defined range of the inertial measurements stored for the mapping. For example, if the mapping is stored with a set of inertial measurements represented by an inertial vector [ax, ay, az, gx, gy, gz, mx, my, mz] (corresponding to the 3 axes of an accelerometer, 3 axes of a gyroscope and 3 axes of a magnetometer), then the set of inertial measurements may be considered to be a match if the set of inertial measurements fall within a range of +/−10% for each entry in the stored inertial vector, or other defined range. In some examples, the range may be defined based on the known or expected dimensions of the display devices 220, among other possibilities.

After a mapping has been identified, the display device 220 mapped by the identified mapping may be identified (e.g., each display device 220 may have a unique identifier that can be used to identify each display device 220 in the stored mappings). The content displayed on the identified display device 220 may then be automatically selected to enable user interaction. For example, a cursor may be displayed or otherwise activated on the identified display device 220. The cursor may be displayed or activated at a previously saved location in the displayed content (e.g., if the user was previously interacting with the content displayed on the identified display device 220, the cursor may be activated again at the location of the last user interaction). Thus, the user may immediately begin interacting with the content displayed on the identified display device 220, without having to manually select the content.

In some examples, step 408 may be performed after determining that the inertial measurements have been relatively steady (e.g., changing by less than 5%) for a defined period of time (e.g., 0.5s), to avoid inadvertently enabling user interactions when the user is still moving their head. Following step 408, the method 400 may return to step 404 to continue monitoring the inertial measurements.

Returning to step 404, if the set of inertial measurements do not indicate user movement above a defined threshold and there is no stored mapping matching the set of inertial measurements, the method 400 proceeds to step 410.

At 410, a user interaction associated with a given display device 220 is detected (if there is no user interaction detected contemporaneous with the obtained set of inertial measurements, the method 400 may return to step 404). The user interaction may be, for example, user input (e.g., via mouse input, keyboard input, touch input, etc.) to interact with content displayed on the given display device 220, or user input selecting the given display device 220 (e.g., via voice input identifying the given display device 220, via input of a function key to select the display device 220, etc.). The detected user interaction indicates that the user's visual attention is currently on the given display device 220. The detected user interaction occurs contemporaneously with the set of inertial measurements obtained at step 404.

How the user interaction is detected may depend on the embodiment of the computing system that is carrying out the method 400. For example, if the method 400 is being implemented on the electronic device 200, the electronic device 200 may directly detect the user interaction and identify the given display device 220 associated with the user interaction. If the method 400 is being implemented on the wearable device 100, the user interaction and the given display device 220 associated with the user interaction may be directly detected by the electronic device 200. The electronic device 200 may then send a signal to the wearable device 100 indicating the detection of the user interaction associated with the given display device 220; in this way, the wearable device 100 may indirectly detect the user interaction associated with the given display device 220. A similar process may occur if the method 400 is being implemented on another computing device (e.g., a smartphone) that is not the electronic device 200.

At 412, a mapping is generated to map between the set of inertial measurements and the given display device 220. The mapping is caused to be stored in memory. The given display device 220 is now considered to be registered by the display registration module 310. In this way, the inertial sensor 110 of the wearable device 100 may be implicitly calibrated with respect to the given display device 220. In some examples, the mapping is generated when the inertial measurements have been relatively steady (e.g., changing by less than 5%) for a defined period of time (e.g., 0.5s).

The generation of the mapping and the storing of the mapping may take place in different computing systems. For example, if the method 400 is being implemented on the wearable device 100 and the wearable device 100 lacks sufficient storage, the generated mapping may be communicated by the wearable device 100 to another computing system (e.g., to the electronic device 200 or to another computing device such as a smartphone) for storage. In another example, if the wearable device 100 has sufficient storage or if the method 400 is being implemented on the electronic device 200 (or another computing system having a memory), the generation and storing of the mapping may take place on the same computing system.

In some examples, a mapping may be stored in the form of a table that associates an inertial vector representing the set of inertial measurements with an identifier of the given display device 220. In some examples, the set of inertial measurements stored with the mapping may be an average of the inertial measurements obtained over the defined period of time (e.g., 0.5) when the inertial measurements have been relatively steady.

The user may perform further interactions with the given display device 220. The method 400 may return to step 404 to continue monitoring the inertial measurements.

If the user looks away from the given display device 220 and/or interacts with a different display device 220, and then later returns to looking at the given display device 220, the stored mapping may be used to automatically enable user interactions with the given display device 220 again (e.g., as described at step 408).

As previously mentioned, the method 400 may be performed by the wearable device 100, the electronic device 200 or another computing device.

In some examples, the method 400 may be performed by the wearable device 100. The wearable device 100 may have a processing unit with sufficient processing power to generate the mapping between the inertial measurements and a given display device 220. The wearable device 100 may also have a memory in which the generated mapping may be stored. In other examples, the wearable device 100 may be capable of generating the mapping between the inertial measurements and the given display device 220, but may rely on an external device (e.g., the electronic device 200 or another computing device, such as a smartphone, in communication with the wearable device 100) to store the mapping. In yet other examples, the method 400 may be performed by the electronic device 200 or another computing device, using inertial measurements obtained from the wearable device 100.

In some examples, each mapping that is stored may be stored together with a timestamp indicating the time when the mapping was generated and stored. Because an inertial sensor 110 may exhibit drift over time, the stored timestamp may be a useful indicator that a stored mapping needs to be updated. For example, the method 400 may include an additional step of checking the timestamp stored with each stored mapping. If a timestamp stored with a particular mapping is older than a predefined time period (e.g., older than 1 minute compared to the current timestamp), that mapping may be deleted. This may enable a new mapping to be generated and stored, thus enabling updating of the implicit calibration of the inertial sensor 110. At the step 408, if a stored mapping matching the set of inertial measurements is identified, it may be determined whether the timestamp of the identified mapping is older than the predefined time period. If the timestamp of the identified mapping is within the predefined time period, then that mapping may be sufficiently recent and step 408 may proceed as described above. If the timestamp of the identified mapping exceeds the predefined time period, the identified mapping may be deleted and the method 400 may proceed to step 410 instead.

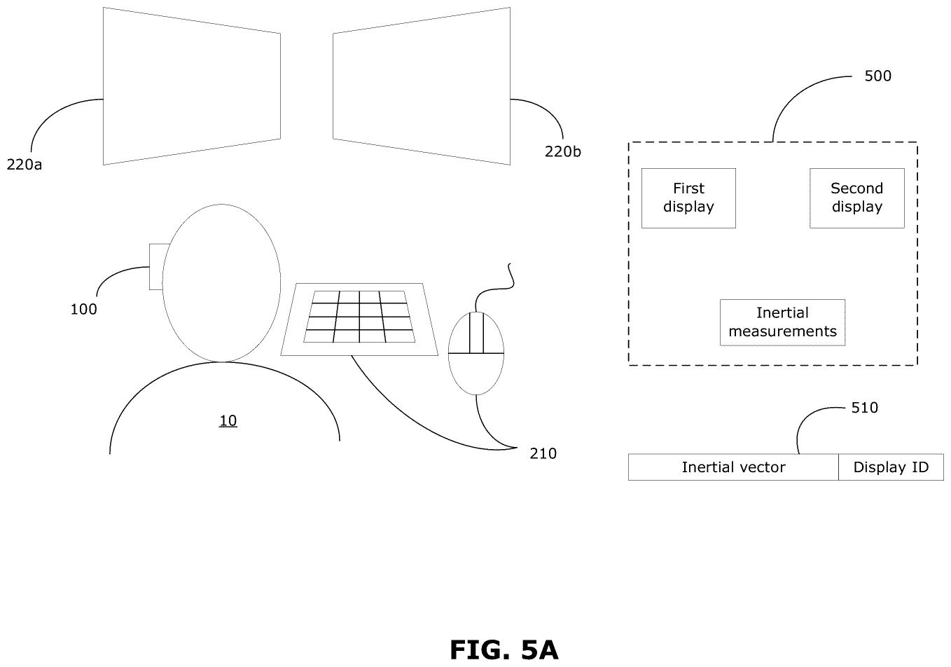

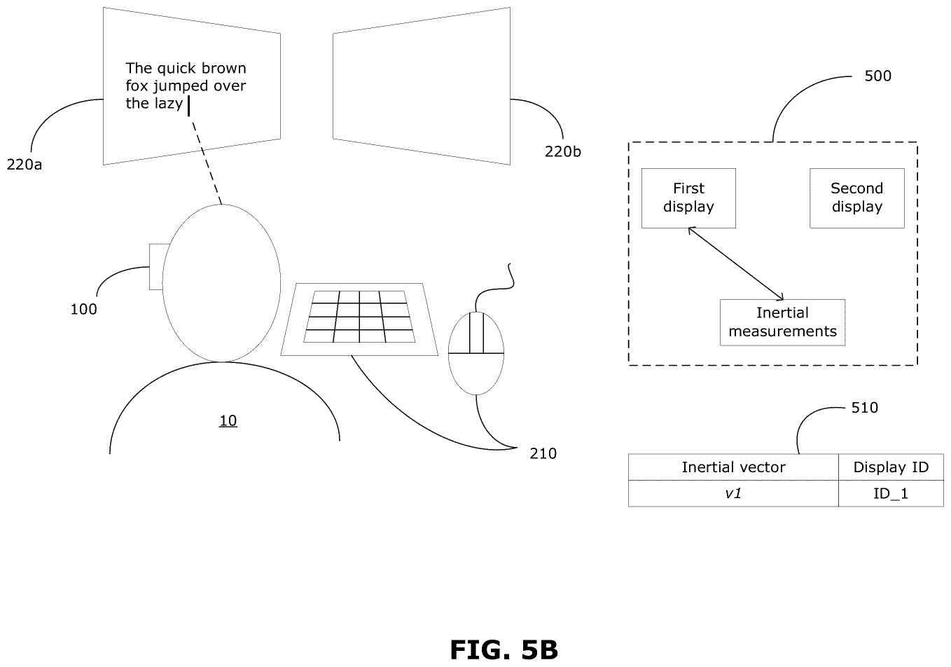

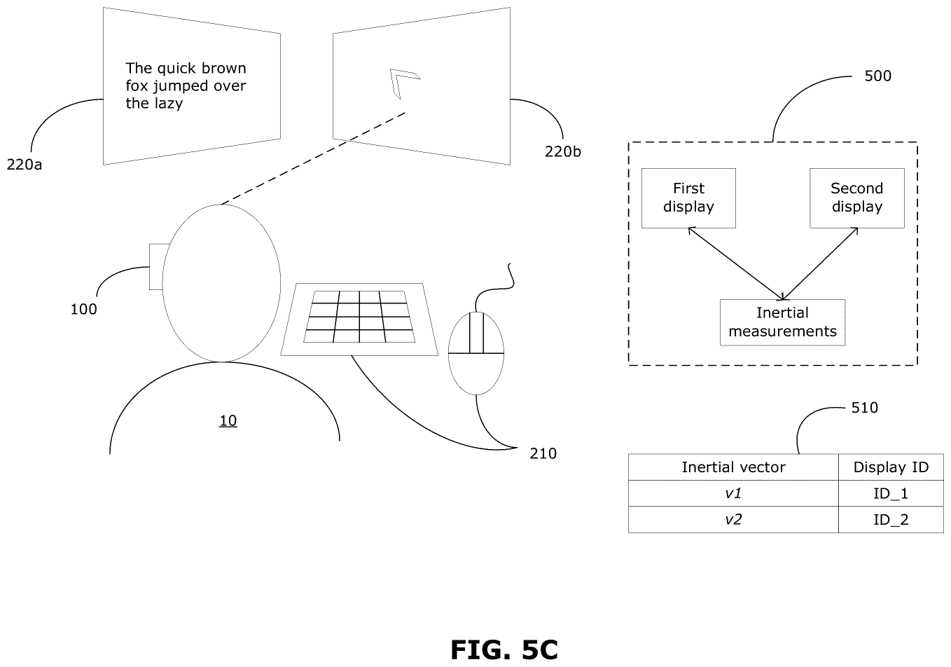

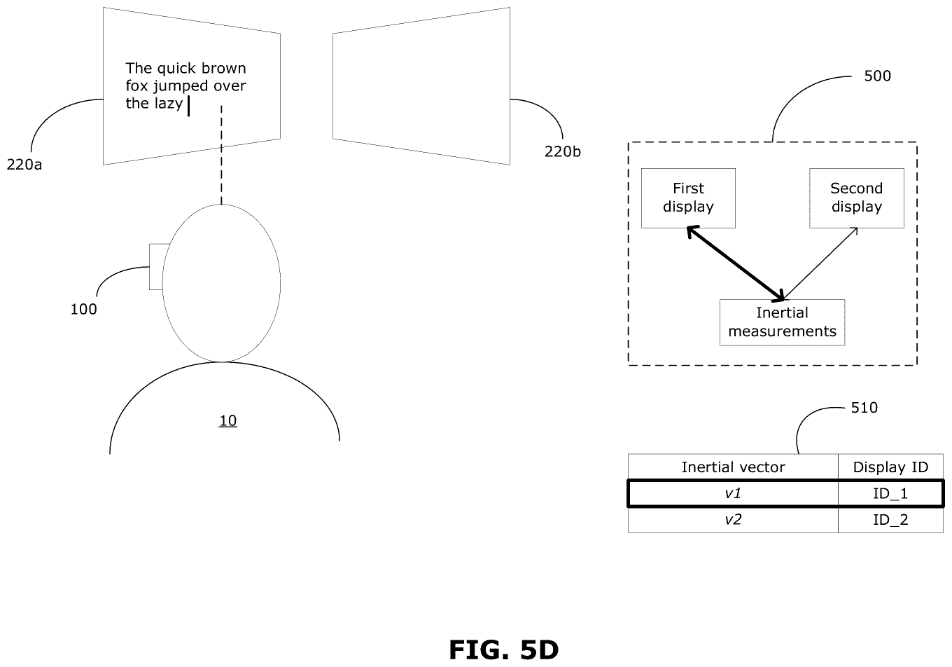

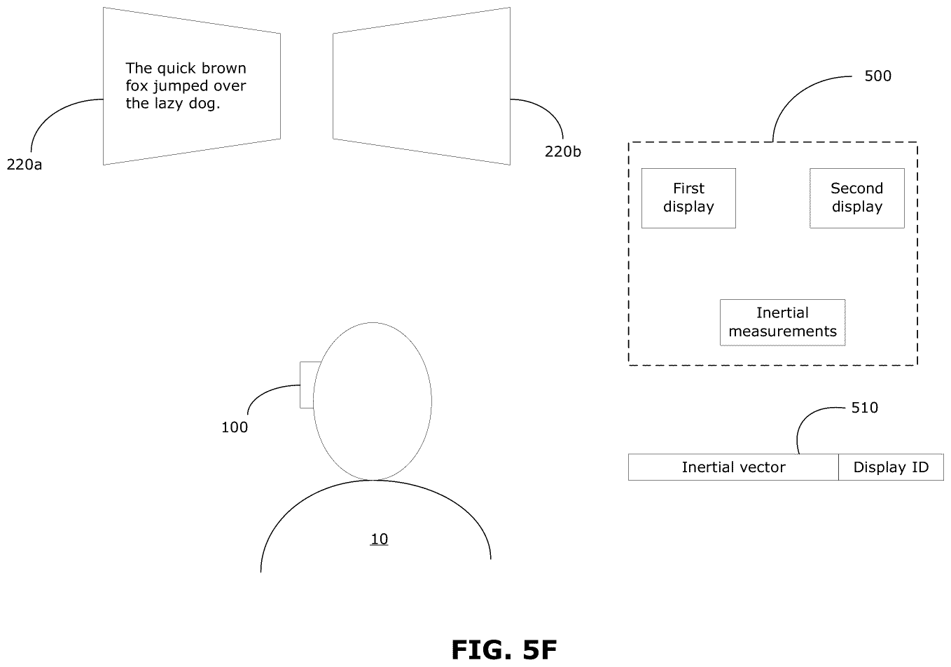

FIGS. 5A-5F illustrate an example implementation of the method 400 in a multi-display desktop setup. In this example, the method 400 may be performed by the electronic device 200 that is in communication with the first and second display devices 220a, 220b and also in communication with the wearable device 100 being worn at or near the head of the user 10. To assist in understanding, FIGS. 5A-5F include a schematic 500 to help illustrating mappings between inertial measurements and the display devices 220, however it may not be necessarily to explicitly generate or display the schematic 500.

FIGS. 5A-5F illustrate a common setup in which the user 10 is interacting with a desktop computer (e.g., the electronic device 200, not shown) over two or more display devices 220, while wearing a wearable device 100 (e.g., headphones) having inertial sensors. The user 10 can interact with content displayed on the display devices 220 using input devices 210 such as a keyboard and a mouse.

In FIG. 5A, there is no mapping between any set of inertial measurements and any of the display devices 220 (as represented by absence of links between the first and second displays and inertial measurements in the schematic 500). A table 510 (which may be stored in a memory of the electronic device 200) storing any generated mappings between inertial measurements (represented by inertial vectors) and display devices may be empty. For example, the user 10 may have just started working and has not yet provided any input or interactions.

In FIG. 5B, there is user interaction associated with the first display device 220a. In this case, the user 10 has inputted text (e.g., using the keyboard) in a text editing application displayed on the first display device 220a, and an active text insertion cursor is displayed on the first display device 220a. In other examples, the user interaction may be touch input, mouse input, voice input, etc. At the same time, a set of inertial measurements is obtained from the wearable device 100, which corresponds to the user's head position while looking at the first display device 220a (indicated by a dashed line). A first mapping is thus generated between the current set of inertial measurements and the first display device 220a (as represented by a new link between the first display and inertial measurements in the schematic 500). The first mapping between the current set of inertial measurements, represented by an inertial vector v1, and the first display device 220a, identified by the device identifier ID_1, is stored in the table 510. In this way, the inertial measurements obtained by the inertial sensor 110 have been implicated calibrated with respect to the first display device 220a.

In FIG. 5C, there is user interaction associated with the second display device 220b. In this case, the user 10 has performed a mouse click or moved a chevron cursor (e.g., using the mouse) on content displayed on the second display device 220b (it may be noted that the text insertion cursor is no longer active on the first display device 220a). In other examples, the user interaction may be touch input, mouse input, voice input, etc. At the same time, another set of inertial measurements is obtained from the wearable device 100, which corresponds to the user's head position while looking at the second display device 220b (indicated by a dashed line). A second mapping is thus generated between the new set of inertial measurements and the second display device 220b (as represented by a new link between the second display and inertial measurements in the schematic 500). The second mapping between the set of inertial measurements, represented by an inertial vector v2, and the second display device 220b, identified by the device identifier ID_2, is stored in the table 510. In this way, the inertial measurements obtained by the inertial sensor 110 have been implicated calibrated with respect to the second display device 220b.

Both the first and second display devices 220a, 220b are now considered to be registered.

In FIG. 5D, the user 10 again turns their head position to look (indicated by a dashed line) at the first display device 220a, but the user 10 does not perform any interaction to select the first display device 220a (indicated by the absence of input devices 210). The table 510 of stored mappings is used to identify if there is any stored mapping that matches the current set of inertial measurements obtained from the wearable device 100. In this case, a match is found with the first mapping (indicated by a thicker link in the schematic 500, and by a thicker outline in the table 510). It may be noted that the first mapping may be identified as matching the current inertial measurements even if the current inertial measurements do not exactly match the stored inertial vector v1. For example, if the current inertial measurements is within a defined margin (e.g., 10%) of the stored inertial vector v1, a match may be identified. This may be represented by the user's head position (indicated by a dashed line) being slightly different between FIG. 5B and FIG. 5D.

As a result of the identified first mapping, the first display device 220a is identified and user interaction with content displayed on the first display device 220a is enabled. For example, the text insertion cursor is activated and displayed again on the first display device 220a. The text insertion cursor may be activated at the same location as the previous user interaction on the first display device 220a (e.g., at the same location as that shown in FIG. 5B). The user may thus immediately begin interacting with content on the first display device 220a (e.g., to enter more text into the text editing application, at the location where they previously were typing) without having to first explicitly select the first display device 220a using mouse input or keyboard input. Thus, examples of the present disclosure may enable the user 10 to more easily transition between different display devices 220, simply based on which display device 220 they are looking at and without requiring explicit selection of the target display device 220. Improved efficiency, for example by decreasing the amount of explicit input that needs to be processed, may be achieved.

In FIG. 5F, the user 10 has moved away from the display devices 220. The inertial measurements obtained from the wearable device 100 indicates user movement above a defined threshold. Accordingly, the display devices 220 are deregistered and the stored mappings are deleted (indicated by the links being removed from the schematic 500, and the table 510 being empty). This deleting of stored mappings may be performed because may inertial sensors 110 tend to exhibit drift in inertial measurements over time. Thus, if the user 10 moves away from the display devices 220 and later returns, the mappings that were previously generated may no longer be valid and new mappings may need to be generated.

If the user 10 moves back to the display devices 220 again (e.g., returning to FIG. 5A), new mappings will be generated and stored.

Optionally, feedback may be provided to the user 10 to indicate that a display device 220 has been registered or that user attention on a particular display device 220 has been determined. For example, a graphical representation similar to the schematic 500 may be displayed (e.g., as a small inset) to show the user 10 whether or not a display device 220 has been registered. In another example, when a stored mapping matches the current inertial measurements and a particular display device 220 has been identified based on the matching mapping, that particular display device 220a may be briefly highlighted (e.g., brightness increased). Other such feedback mechanisms may be used.

Although the previous examples have been described in the context of multi-display interactions where there is a single electronic device 200 in communication with multiple display devices 220, examples of the present disclosure may also support multi-display interactions where there are multiple electronic devices 200 that communicate with the multiple display devices 220. For example, the present disclosure may enable multi-display interactions where there are multiple single-screen electronic devices 200 (e.g., a laptop and a tablet), as well as multi-display interactions where there are multiple electronic devices 200 including an electronic device 200 that controls two or more display devices 220 (e.g., a tablet and a desktop computer, where the desktop computer is connected to two display screens). The different electronic devices 200 may use same or different input modalities (e.g., a tablet may support touch input but a desktop computer may not support touch input).

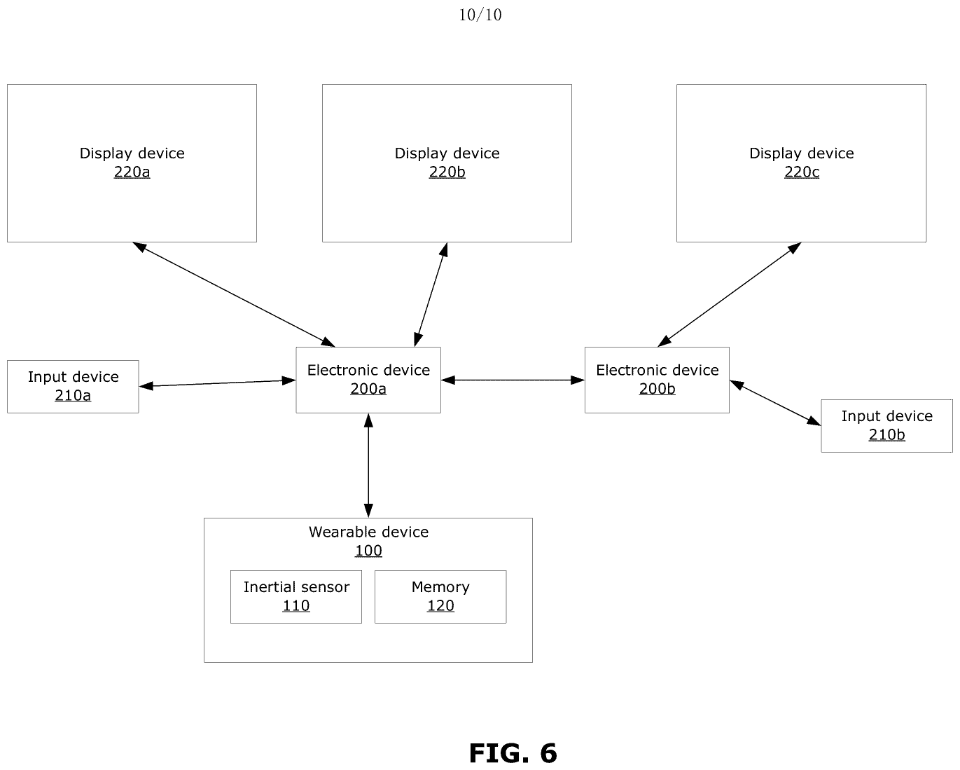

FIG. 6 is a block diagram illustrating an example of the present disclosure implemented in a scenario having multiple electronic devices 200 in communication with the multiple display devices 220.

The example of FIG. 6 is similar to the example of FIG. 2, however there are three display devices 220a, 220b, 220c being controlled by two electronic devices 200a, 200b. In this example, the first electronic device 200a (e.g., a desktop computer) is in communication with the first and second display devices 220a, 220b, and the second electronic device 200b (e.g., a table) is in communication with the third display device 220c. Each electronic device 200a, 200b may receive user input via a respective input device 210a, 210b. The two input devices 210a, 210b may support same or different input modalities.

In this example, the second electronic device 200b is in communication with the first electronic device 200a but not in communication with the wearable device 100. Communications between the wearable device 100 and the second electronic device 200b (e.g., communication of inertial measurements, detected user interactions, etc.) may be via the first electronic device 200a. In other examples, there may be communication directly between the second electronic device 200b and the wearable device 100.

It should be understood that the method 400 may be implemented in the scenario of FIG. 6. For example, if the method 400 is implemented on the first electronic device 200a, the first electronic device 200a may receive communications from the second electronic device 200b to detect a user interaction associated with the third display device 220c. At the same time, the first electronic device 200a may receive a set of inertial measurements from the wearable device 100. The first electronic device 200a may then generate and store a mapping between the received set of inertial measurements and the third display device 220c.

For example, the user may touch a touchscreen of a tablet while looking at the display of the tablet, and the user may input a mouse click while looking at each of the screens connected to the desktop computer. In another example, the user may provide voice input identifying each display device 220 (e.g., verbal input such as “left screen”, “right screen”, “tablet”) while looking at each respective display device 220. In this way, mappings may be generated and stored to register each of the display devices 220.

Then at a later time, when inertial measurements from the wearable device 100 match the stored mapping, the first electronic device 200a may identify the third display device 220c as the target of the user's visual attention, and may communicate with the second electronic device 200b to enable user interaction with content displayed on the third display device 220c.

In this way, enabling user interaction to easily transition between different display devices 220 may implicitly also enable the user to easily interact between different electronic devices 200. In some examples, if the different electronic devices 200 support a common input modality, the different electronic devices 200 may communicate user input with each other, so that user input received at the first input device 210a connected to the first electronic device 200a may be communicated to the second electronic device 200b. This may enable the user to interact with the different electronic devices 200 with a single input device 210 (that uses the common input modality), by using head movement to transition between the different display devices 220 of the different electronic devices 200 instead of having to switch to a different input device 210 for interacting with each different electronic device 200.

In some examples, after each display device has been registered (i.e., a respective mapping has been generated and stored), head-based user interactions may be supported while the user is wearing the wearable device 100 with inertial sensor 110.

In an example, each display device 220 may maintain display of a cursor at the location of the last user interaction, even if the cursor is not active (i.e., even if the cursor is not currently being used for user interaction). Then, when the user's attention turns to a particular display device 220 (as determined by the inertial measurements matching a mapping corresponding to the particular display device 220), the user may immediately begin interacting with the content starting from the position of the now-activated cursor.

In another example, scrolling input (e.g., using a scroll button on a mouse) while the user's attention is on a particular display device 220 (as determined by the inertial measurements matching a mapping corresponding to the particular display device 220) may be used as a command to scroll the content displayed on the particular display device 220.

In another example, while the user's attention is on the first display device 220a (as determined by the inertial measurements matching a mapping corresponding to the first display device 220a), the user may select (e.g., using a mouse click) an object (e.g., icon, window, etc.) displayed on the first display device 220a. Then instead of using conventional drag input (e.g., using movement of the mouse) to move the selected object, the user may move their head to drag the selected object. This may be used to drag the selected object within the first display device 220a, or may be used to drag the selected object to a different display device (e.g., to the second display device 220b), for example.

In another example, while the user's attention is on the first display device 220a (as determined by the inertial measurements matching a mapping corresponding to the first display device 220a), the user may use a defined head motion or defined head pose (e.g., moving head up or down) to control display parameters (e.g., brightness).

In another example, while the user's attention is on the first display device 220a (as determined by the inertial measurements matching a mapping corresponding to the first display device 220a), the user may be typing text input that is displayed on the second display device 220b. For example, the user may be reading text content displayed on the first display device 220a and typing the text content into a text entry field displayed on the second display device 220b. The user's visual attention may be initially on the second display device 220b on which the text is being inputted, then while continuing to provide text input the user's visual attention may turn to the first display device 220a. An overlay or textbox may be displayed on the first display device 220a to show a portion of the text being typed (e.g., a portion of the text input displayed on the second display device 220b), so that the user can more easily check their text input without having to switch attention between the first and second display devices 220a, 220b. It may be noted that such a user interaction, in which the user's visual attention is on one display device 220 while user input is provided on a different display device 220, may take place after mappings for all display devices 220 have been generated and stored. Further, in this example, the continuous user input associated with the second display device 220b may override activation of a cursor on the first display device 220a (which would otherwise occur when the user turns their visual attention to the first display device 220a in absence of continuous user input associated with the second display device 220b).

In various examples, the present disclosure has described methods and systems that enable an inertial sensor of a wearable device (e.g., smartglasses, smart headphone, etc. having an IMU or IMMU) to be implicitly calibrated with display devices in a multi-display setup. This may help to improve the efficiency of user interactions, as well as improving efficiency in processing since fewer user inputs may be required.

Examples of the present disclosure may be used to generate and store mappings between inertial measurements and display devices, based on user interactions associated with each display device. Possible user interactions include mouse input, keyboard input, touch input, and voice input, among others.

Using examples disclosed herein, a user may more easily switch the active cursor between different display devices. When a cursor is activated on a display device, the cursor may be automatically located at the position of the last user interaction on that display device, without requiring explicit user input.

Examples of the present disclosure may be implemented in a multi-display setup where the multiple display devices are controlled by a single electronic device, or where the multiple display devices are controlled by multiple electronic devices, which may use the same or different input modalities.

Although the present disclosure describes methods and processes with steps in a certain order, one or more steps of the methods and processes may be omitted or altered as appropriate. One or more steps may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable an electronic device to execute examples of the methods disclosed herein.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A method comprising:
obtaining a first set of inertial measurements representing motion of a head of a user; and
determining a first mapping between the first set of inertial measurements and a first display device when detecting a first user interaction associated with the first display device of a plurality of display devices.

2. The method of claim 1, further comprising:
causing the first mapping to be stored.

3. The method of claim 1, further comprising:
obtaining a subsequent set of inertial measurements representing subsequent motion of the head of the user;
identifying the first mapping matching the subsequent set of inertial measurements; and
enabling further user interaction with content displayed on the first display device, based on the identified first mapping.

4. The method of claim 3, wherein enabling the further user interaction comprises:
activating a cursor on the first display device, the cursor being activated at a location corresponding to a last user interaction on the first display device.

5. The method of claim 3, wherein enabling the further user interaction comprises:
detecting scrolling input; and
causing content displayed on the first display device to be scrolled based on the scrolling input.

6. The method of claim 3, wherein enabling the further user interaction comprises:
controlling a display parameter of the first display device.

7. The method of claim 1, wherein the first user interaction is one of:
voice input identifying the first display device;
keyboard input to interact with content displayed on the first display device;
mouse input to interact with content displayed on the first display device; or
touch input sensed by a touch sensor of the first display device.

8. The method of claim 1, further comprising:
obtaining a second set of inertial measurements representing motion of the head of the user; and
determining a second mapping between the second set of inertial measurements and a second display device when detecting a second user interaction associated with the second display device of the plurality of display devices;
wherein, in response to obtaining another set of inertial measurements matching the first mapping, user interaction with content displayed on the first display device is enabled; and
wherein, in response to obtaining another set of inertial measurements matching the second mapping, user interaction with content displayed on the second display device is enabled.

9. The method of claim 8, further comprising:
causing the second mapping to be stored.

10. The method of claim 8, further comprising:
detecting selection of an object displayed on the first display device;
obtaining a third set of inertial measurements representing motion of the head of the user;
identifying the second mapping matching the third set of inertial measurements; and
causing the selected object to be moved to be displayed on the second display device, based on the identified second mapping.

11. The method of claim 1, further comprising:
obtaining a further set of inertial measurements indicating user movement above a defined threshold; and
causing all stored mappings to be deleted.

12. The method of claim 1, wherein the plurality of display devices is controlled by a single electronic device.

13. The method of claim 1, wherein the plurality of display devices is controlled by multiple electronic devices.

14. The method of claim 1, wherein inertial measurements are obtained from an inertial sensor of a wearable device worn on or near the head of the user.

15. A computing system comprising:
a processing unit configured to execute computer readable instructions to cause the computing system to:
obtain a first set of inertial measurements representing motion of a head of a user; and
determine a first mapping between the first set of inertial measurements and a first display device when detecting a first user interaction associated with the first display device of a plurality of display devices.

16. The computing system of claim 15, wherein the processing unit is further configured to execute the computer readable instructions to cause the computing system to:
obtain a subsequent set of inertial measurements representing subsequent motion of the head of the user;
identify the first mapping matching the subsequent set of inertial measurements; and
enable further user interaction with content displayed on the first display device, based on the identified first mapping.

17. The computing system of claim 15, wherein the first user interaction is one of:
voice input identifying the first display device;
keyboard input to interact with content displayed on the first display device;
mouse input to interact with content displayed on the first display device; or
touch input sensed by a touch sensor of the first display device.

18. The computing system of claim 15, wherein the processing unit is further configured to execute the computer readable instructions to cause the computing system to:
obtain a second set of inertial measurements representing motion of the head of the user; and
determine a second mapping between the second set of inertial measurements and a second display device when detecting a second user interaction associated with the second display device of the plurality of display devices;
wherein, in response to obtaining another set of inertial measurements matching the first mapping, user interaction with content displayed on the first display device is enabled; and
wherein, in response to obtaining another set of inertial measurements matching the second mapping, user interaction with content displayed on the second display device is enabled.

19. The computing system of claim 15, further comprising:
an inertial sensor configured to obtain the set of inertial measurements;
wherein the computing system is configured to be wearable on or near the head of the user.

20. A non-transitory computer readable medium having instructions encoded thereon, wherein the instructions are executable by a processing unit of a computing system to cause the computing system to:
obtain a first set of inertial measurements representing motion of a head of a user; and
determine a first mapping between the first set of inertial measurements and a first display device when detecting a first user interaction associated with the first display device of a plurality of display devices.
